(19) United States
(12) Patent Application Publication
(10) Pub. No.: US 2025/0378709 A1
(43) Pub. Date: Dec. 11, 2025

(54) IMAGE RECOGNITION PROCESS FOR A RECOGNITION DOCUMENT

(71) Applicant: PHERSEI S.R.L., Milano (IT)

(72) Inventor: Marzio FERRARIO, Milano (IT)

(21) Appl. No.: 18/874,193

(22) PCT Filed: Jun. 28, 2023
(86) PCT No.: PCT/IT2023/050155

§ 371 Date: Dec. 12, 2024

(30) Foreign Application Priority Data
Jun. 30, 2022 (IT) 102022000013813

(51) Int. Cl. G06V 30/42; G06V 20/00

(52) U.S. Cl. CPC G06V 30/42; G06V 20/95

(57) ABSTRACT

Some embodiments relate to an image recognition process, to verify an authenticity of a recognition document by means of an acquisition of at least one image of the recognition document, wherein the process is implemented on an electronic computer comprising at least one processor for performing operations of the process and at least one memory. The process can include a step of acquisition; a plurality of verification steps comprising type verification step, structural control step, compilation analysis step, compatibility verification step, evaluation step; a plurality a varification steps of discrepancy; and a step of generation of an outcome.

### CROSS-REFERENCE TO RELATED APPLICATIONS

This application is a national phase filing under 35 C.F.R. § 371 of and claims priority to PCT Patent Application No. PCT/IT2023/050155, filed on Jun. 28, 2023, which claims the priority benefit under 35 U.S.C. § 119 of Italian Patent Application No. 102022000013813, filed on Jun. 30, 2022, the contents of which are hereby incorporated in their entireties by reference.

### BACKGROUND OF THE DISCLOSURE

### 1) Field of the Disclosure

The presently disclosed subject matterrelates to a process for recognizing an identification and/or identity document, in particular a process of images to verify the veracity or authenticity of a recognition document.

### 2) Background Art

In the state of the art, the contractual relationships between various companies and their customers and/or users of services have evolved in a virtual sense. As a result, the use of web services in the management of business processes has increased, always more oriented towards implementing remote methods, so-called smart methods.

Data acquisition methods have undergone a further acceleration due to the tragic implications of the health emergency we are facing. Company processes provide for the presentation of an identification or identity document through a presentation of the original document to a natural person belonging to the organization with its contextual digital acquisition, a scan/photograph sent via the web by the document holder, an acquisition visual and digital during video-interviews via computer, webcam or smartphone.

The identification documents, which will subsequently have considerable importance in the establishment of lasting economic relationships, will necessarily have to check to an authenticity verification process as a function of a serious and effective anti-fraud strategy, and to corporate compliance measures that the legal entity must integrate into their business processes.

Identification documents are understood to mean an Italian identity card, a fiscal code, a health card or other foreign identification documents extended to a wider variety of documents, including Italian and foreign passports, driving licenses, foreign identification cards, permits residence and so on.

Advantageously, only a specialized analysis can verify the veracity of the documents by accessing both the monographic information of the individual types of identity documents, and those of a transversal nature characterizing wider and more diversified document models.

The presentation of the identification document, even in its physical meaning, is a prelude to the verification of the copy, which usually takes place subsequently, rarely at the same time as the opening of the report.

This period of time, which can vary within the individual company process, should include a verification of the authenticity of the document produced, in order to prevent the possibility of the illicit opening of a relationship.

Advantageously, the individual corporate entities, even in which there are verifiers, often have to process large quantities of documents in a way that lacks both time and analytical methods.

Showing false documents has various purposes, which, as it is easy to understand, are above all of an economic nature, aiming to obtain illicit profits by exploiting system flaws and the unavailability of the authors of the criminal project. In this sense, fictitious identities can be created or, in an even more pernicious way, the identities of unaware subjects can be taken over. In both cases, the documents presented are in any case irregular; they are the result of various forgery techniques, from the simple replacement of the photographic image of the holder to the creation of counterfeit documents. The falsification of the document can be of a “physical” nature, using an altered or counterfeited “real” support, or it can simply be achieved through a computerized graphic construction, if the document is acquired by the organization with online tools.

Disadvantageously, recognition of an identification document via the Internet does not have the possibility of direct verification of the original document through the analysis of an operator, who could at least ascertain that the image of the photograph on the document corresponds to the face of its holder, inevitably the issue arises of implementing a subsequent check of the image of the forwarded document, not having the possibility of checking the original.

Disadvantageously, even in the presence of a company operator who physically acquires the original document, he rarely possesses the knowledge and technical tools useful for a professional verification of authenticity. This would also presuppose the availability of sufficient technical times, which do not combine well with the necessary speed of establishment of the bureaucratic practices inherent in the acquisition of data.

The advent of computerization has brought with it the urgency of speeding up relations between private and institutional subjects, which has meant that today there is no transaction that cannot, or exclusively must, be performed remotely or smartly. The identity documents are thus transmitted electronically in the form of scans, on the hand speeding up the establishment of relationships, on the other generating serious security problems regarding the authenticity, if not the material existence, of the transmitted document and of its content.

This evolution of trust relationships established via the web has apparently eliminated the possibility of fulfilling the ‘filter’ function once performed by those who physically received the document in their hands.

### SUMMARY OF THE DISCLOSURE

The object of the present disclosure consists in realizing an image recognition method, which is capable of verifying the truthfulness of an identification document acquired remotely by means of at least one image.

In accordance with the presently disclosed subject matter this object is achieved with an image recognition method for verifying the veracity of an identification document according to claim 1.

A further object of the presently disclosed subject matter consists in realizing an electronic computer program capable of implementing an image recognition process, which is capable of verifying the truthfulness of an identification document acquired remotely by means of at least one image.

In accordance with the presently disclosed subject matter this further object is achieved with a computer program according to claim 12.

Other characteristics are foreseen in the dependent claims.

### BRIEF DESCRIPTION OF THE DRAWINGS

The characteristics and advantages of the presently disclosed subject matter will become more evident from the following description, by way of example and not of limitation, referred to the attached schematic drawings in which:

FIG. 1 is a schematic view of an image recognition process of an identification document according to the presently disclosed subject matter;

FIG. 2 is a schematic view of an alternative recognition process according to the presently disclosed subject matter;

FIG. 3 is a schematic view of the image of an identification document to be verified through the process of the presently disclosed subject matter;

FIG. 4 is a schematic view of a step of acquiring an image and of a sub-step of dividing the image into a multiplicity of sub-sections of the image;

FIG. 5 is a schematic view of a verification step called typology verification step;

FIG. 6 is a schematic view of a verification step called structural control step;

FIG. 7 is a schematic view of a verification step called compilation analysis step;

FIG. 8 is a schematic view of a verification step called compatibility verification step;

FIG. 9 is a schematic view of a verification step called evaluation step;

FIG. 10 is a schematic view of a step for verifying typological discrepancies (210);

FIG. 11 is a schematic view of a structural non-conformity verification step (220);

FIG. 12 is a schematic view of a step for verifying compilation discrepancies (230);

FIG. 13 is a schematic view of a step for verifying non-compatibility differences (240); and

FIG. 14 is a schematic view of a step of evaluation discrepancy verification (250).

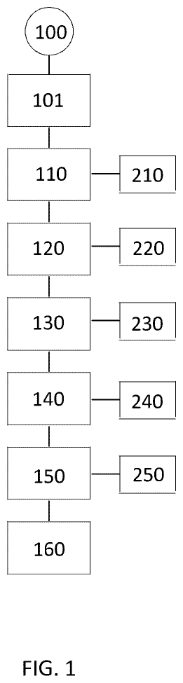

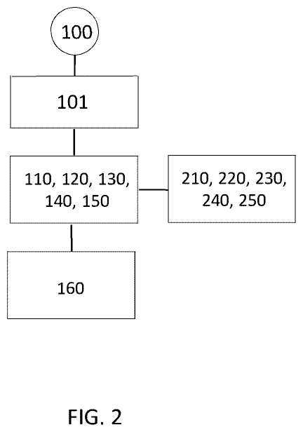

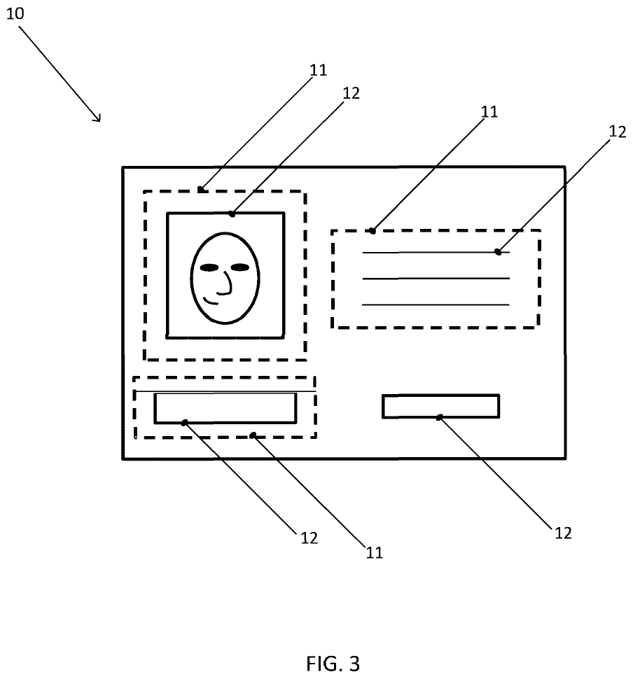

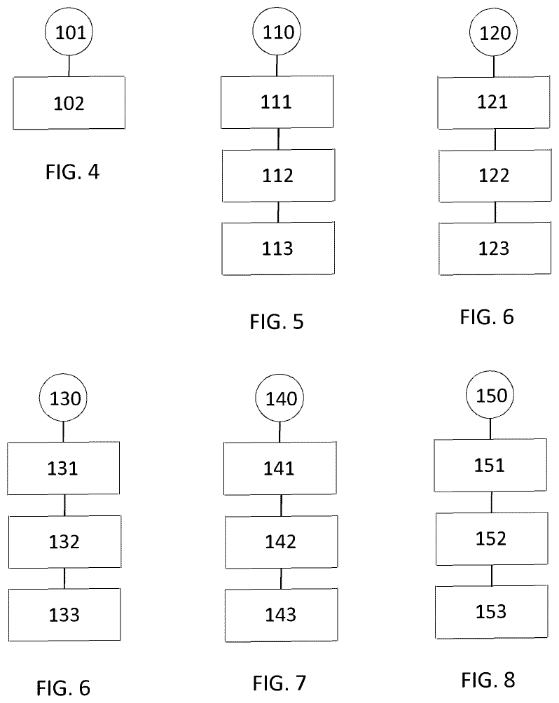

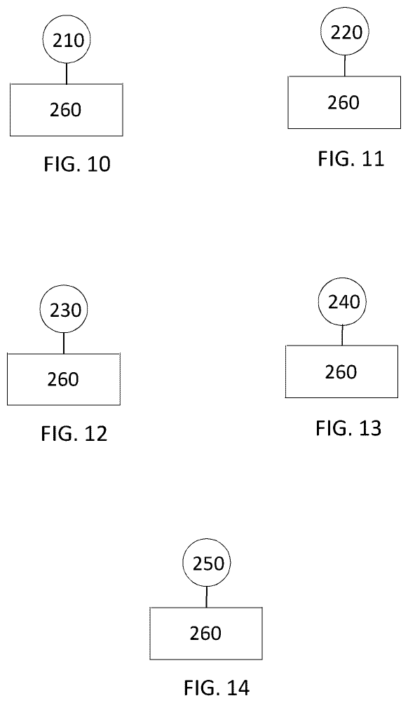

### DETAILED DESCRIPTION OF PREFERRED EMBODIMENTS

With reference to the cited figures, an image recognition process 100 is show for verifying the truthfulness of an identification document by means of an acquisition of at least one image 10 of the identification document.

The image 10 of the identification document is acquired remotely and transmitted to the process 100 for verifying the truthfulness of the identification document.

The process 100 for recognizing the remote identification document proposes a new vision of documentary control which is modulated through a previous experience of documentary control by the police and an in-depth study of Italian and foreign identification documents, their content, the respective anti-counterfeiting systems and production techniques.

The process 100 advantageously exploits a series of information that is difficult to find and of absolute novelty capable of raising the level of recognition of the falsifications referring to the most frequent cases, reducing the risk of falling victim to frauds, swindles, economic and reputational damages.

The nature of the Italian and foreign identification documents, thanks to a series of exclusive information deriving from the verification process, is revealed in its possible falsifications by the process 100.

The process 100 is implemented on an electronic processor comprising at least one processor which executes operations of the process 100 and analyzes the document in its entirety through at least one image 10 of the document, at least one memory containing a file and instructions for the processor, where by act or document means any identification or identity document or containing identification data of a person.

The process 100 comprises an acquisition step 101 of the image 10 of the identification document whose veracity is to be analysed.

The acquisition step 101 comprises a division sub-step 102 which divides the image 10 into a plurality of image sections 11.

The division step 102 is advantageous for concentrating the analysis of the process 100 on pre-set sensitive areas 12, where the pre-set sensitive areas 12 are a collection of multiplicity of image sections 11 10 chosen on the basis of a type of document and which correspond to preset sensitive areas 12 of the original document.

The process 100 comprises the acquisition step 101 of the image 10 of the identification document, at least one verification step 110, 120,130, 140, 150), a step for generating an outcome 160 which determines the originality or falsity of the identification document on the basis of a match between the piece of data extracted from the pre-set sensitive area 12 of the image and the validity parameter present in the memory. The verification step 110, 120,130, 140, 150 comprises an identification sub-step 111, 121, 131, 141, 151 of at least one pre-set sensitive area 12 which provides for identifying a presence of the pre-set sensitive area 12 at the interior of the image 10; a comparison sub-step 112, 122, 132, 142, 152 between the pre-set sensitive area 12 within the image 10 and at least one pre-set sensitive area 12 of at least one comparison image of at least one document of recognition of the sample present in the memory; an extraction sub-step 113, 123, 133, 143, 153 of at least one datum from the pre-set sensitive area 12 of the image 10; a discrepancy verification step 210, 220, 230, 240, 250 between the data extracted from the pre-set sensitive area 12 of the image 10 and at least one validity parameter present in the memory.

The validity parameter comprises at least one datum extracted from other pre-set sensitive areas 12 of the same at least one image 10 through the process 100; at least one datum extracted from the pre-set sensitive area 12 of the sample identification document; data intervals of the data extracted from the pre-set sensitive area 12 of the sample identification document; at least one calculation algorithm for calculating the data of the sample identification document.

The stages discussed above are preferably in chronological order. Preferably the discrepancy verification step 210, 220, 230, 240, 250 comprises a score signaling sub-step 260 which assigns a statistical weight to each extracted data based on the correspondence of the extracted data with the validity parameter. Furthermore, the result generation step 160 sums statistical weights of each extracted data and determines the originality or falsity of the document on the basis of a result of the sum of a multiplicity of statistical weights assigned to a multiplicity of the data extracted from the pre-set sensitive area 12 of the image 10.

Preferably, the data extracted from at least one of the pre-set sensitive areas 12 of the image 10 is an image and that the discrepancy verification step 210, 220, 230, 240, 250 compares the image with the validity parameters, wherein the validity parameters are images.

For example, a stamp reported in the pre-set sensitive area 12 and a stamp present in the memory archive are compared.

Preferably, the discrepancy verification step 210, 220, 230, 240, 250 compares the data extracted from at least one of the pre-set sensitive areas 12 of the image 10 with at least one data extracted from other pre-set sensitive areas 12 of the itself at least one image 10.

For example, it is checked that the stamp issuing body corresponds with that of other pre-set sensitive zones 12 where the name of the stamp issuing body is contained, for example the Municipality.

For example, the master data is checked with the expiry date of the document as in some documents the expiry date corresponds to the day and month of birth.

Preferably, the discrepancy verification step 210, 220, 230, 240, 250 compares the datum 30 extracted from at least one of the pre-set sensitive areas 12 of the image 10 with at least one datum extracted from other pre-set sensitive areas 12 at least one image of the same 10.

For example, it is checked that the stamp issuing body corresponds with that of other pre-set sensitive zones 12 where the name of the stamp issuing body is contained, for example the Municipality.

For example, the master data is checked with the expiry date of the document as in some documents the expiry date corresponds to the day and month of birth.

Preferably, the discrepancy verification step 210, 220, 230, 240, 250 compares the data extracted from at least one of the pre-set sensitive areas 12 of the image 10 with the data extracted from pre-set sensitive areas 12 of sample identification documents.

For example, the verification that at least one part of the serial number extracted from the pre-set sensitive area 12 of image 10 corresponds to a serial number present in the memory.

Preferably, the discrepancy verification step 210, 220, 230, 240, 250 compares the data extracted from at least one of the pre-set sensitive areas 12 of the image 10 with the data ranges of sample identification documents.

For example, it is verified that at least a part of the serial number extracted from image 10 corresponds to a range of serial number values of documents published in a period of time corresponding to the issue of the document itself.

Preferably, the discrepancy verification step 210, 220, 230, 240, 250 compares the data extracted from at least one of the pre-set sensitive areas 12 of the image 10 with a result of the extracted data calculated through calculation algorithms of sample identification document data.

For example, it is verified that the tax code data corresponds to the personal data extracted from pre-set sensitive areas 12 of image 10 by implementing an algorithm that calculates the tax code.

Preferably, the process 100 comprises a plurality of verification steps 110, 120, 130, 140, 150: a type verification step 110, a structural control step 120, a compilation analysis step 130, a compatibility check step 140, an evaluation step 150.

The presence of all these verification steps 110, 120, 130, 140, 150 allows for a greater probability of verifying the truthfulness of the identification document automatically by the process 100 without using human personnel.

The process 100 comprises the verification step of the type 110 of the document which provides for comparing the image 10 of the document and images of similar authentic original documents, so-called specimens, contained in the memory.

The typological verification step 110 comprises a typological identification sub-step 111 of at least one pre-set sensitive area 12 which provides for identifying a presence of the pre-set sensitive area 30 12 within the image (10), for example where the type of document is written, for example identity card, driving license, health card.

The typological verification step 110 comprises a typological comparison sub-step 112 between the pre-set sensitive area 12 within the image 10 and at least one pre-set sensitive area 12 of at least one comparison image of at least one document of sample recognition present in the memory, for example where the type of document is written on the original document.

The typological verification step 110 comprises a typological extraction sub-step 113 of at least one data from the pre-set sensitive area 12 of the image 10, for example it is possible to proceed with a reading of the image by means of an OCR to extract the name of the document type.

The process 100 comprises a step of verifying typological differences 210 between the data extracted from the pre-set sensitive area 12 of the image 10 and at least one validity parameter present in the memory.

For example, you can compare the alignment of the writing that shows the type of document with the graphic structure of the document, the color of the writing, the font of the writing and so on.

Finally, the process 100 comprises the step of generating the result of the verification 160 which assigns a score or a statistical weight to the data based on its correspondence with one or more parameters of validity and helps to determine the originality or falsity of the document of recognition based on the correspondence between the datum extracted from the pre-set sensitive area of the image and the validity parameter present in the memory.

An electronic archive memory or an electronic archive accessible via the Internet or intranet can also be considered as computer memory.

Preferably, once the typology verification step 110 has identified a document typology, then the other subsequent steps are performed, but alternatively it is also possible that the steps are not in the order that we present in the description, but have a different order.

The process 100 comprises a structural control step 120 of at least one section 11 of the image 10 of the deed comprising pre-printed parts.

The pre-printed parts are considered as pre-set sensitive zones 12 and all the pre-printed parts form the structure of the identification document.

The structural verification step 120 comprises a structural identification sub-step 121 of at least one pre-set sensitive area 12 which provides for identifying a presence of the pre-set sensitive area 12 within the image 10, for example the alignments of the preprinted parts of the document.

The structural verification step 120 comprises a structural comparison sub-step 122 between the pre-set sensitive area 12 within the image 10 and at least one sensitive area 30 pre-set 12 of at least one comparison image of at least one sample recognition document present in the memory, for example the alignments of the pre-set sensitive areas 12 of the image 10 which contain pre-printed parts of the document are compared with the corresponding alignments of the original documents present in the memory.

The structural verification step 120 comprises a structural extraction sub-step 123 of at least one data from the pre-set sensitive area 12 of the image 10, for example one can proceed with a reading via OCR of the pre-printed parts, or compare the fonts of the pre-printed parts, their color or their format.

The process 100 comprises a step for verifying the structural discrepancy 220 between the data extracted from the pre-set sensitive area 12 of the image 10 and at least one validity parameter present in the memory.

For example, you can compare the alignment of the pre-printed parts with the graphic structure of the original document, the color of the pre-printed parts, the font and so on.

Finally, the process 100 comprises the step of generating the result of the verification 160 which assigns a score or a statistical weight to the data based on its correspondence with one or more parameters of validity and helps to determine the originality or falsity of the document of recognition based on the correspondence between the datum extracted from the pre-set sensitive area of the image and the validity parameter present in the memory.

The process 100 comprises a step of analysis of the compilation 130 with particular attention to all the information added during the release step of the document.

The compilation analysis step 130 is similar to the previous structural control step 120 in that the compilation analysis step 130 selects at least one section 11 of the image of the document which includes compiled parts. Filled-in parts are treated as pre-set hotspots 12 and are usually found next to or below the pre-printed parts of the document.

The compilation verification step 130 comprises a compilation identification sub-step 131 of at least one pre-set sensitive area 12 which provides for identifying a presence of the pre-set sensitive area 12 within the image 10, for example the alignments of the pre-printed parts of the document. For example, you are looking for the area close to the pre-printed parts where the document data is compiled.

The compilation verification step 130 comprises a compilation comparison sub-step 132 between the pre-set sensitive area 12 within the image 10 and at least one pre-set sensitive area 12 of at least one comparison image of at least a sample identification document present in the memory, for example the alignments between the filled-in area and the pre-printed area, the fonts used for the writings present in the filled-in area are compared.

The compilation verification step 130 comprises a sub-step of extraction of the compilation 133 of at least one data from the pre-set sensitive area 12 of the image 10, for example it is possible to proceed with a reading via OCR of the compiled parts, or compare the fonts of the compiled parts, their color or their format.

The process 100 comprises a step for verifying the non-conformity of the compilation 230 between the data extracted from the pre-set sensitive area 12 of the image 10 and at least one validity parameter present in the memory.

For example, you can compare the alignment of the pre-printed parts with the compiled parts, the color, the fonts and so on.

Finally, the process 100 comprises the step of generating the result of the verification 160 which assigns a score or a statistical weight to the data based on its correspondence with one or more parameters of validity and helps to determine the originality or falsity of the document of recognition based on the correspondence between the datum extracted from the pre-set sensitive area of the image and the validity parameter present in the memory.

The process 100 comprises a compatibility verification step 140 which verifies at least one section 11 of the image 10 of the document where there are pre-set sensitive areas 12, in which the pre-set sensitive areas 12 include particular graphics and/or character fonts and/or drawings that are used in a period of time in which this type of document was originally produced. These details change with the release period of the original document, therefore the presence or absence of these details in the pre-set sensitive areas 12 makes it possible to ascertain whether the type of document corresponds with those produced in the same time period in an authentic way. The compatibility verification step 140 provides that the verification is carried out by the processor through a comparison between the section 11 of the image 10 with the same section 11 of an image of the original document present in the memory.

The compatibility check step 140 comprises a structural identification sub-step 141 of at least one pre-set sensitive area 12 which provides for identifying a presence of the pre-set sensitive area 12 within the image 10, for example the identified pre-set sensitive areas 12 where there are parts of the serial number of the document and expiry or publication dates of the document.

The compatibility check step 140 comprises a compatibility comparison sub-step 142 between the pre-set sensitive area 12 within the image 10 and at least one 20 pre-set sensitive area 12 of at least one comparison image of at least one sample identification document present in the memory, for example the data of the serial numbers are compared with serial data present in the memory and compatible with the publication period of the document.

The compatibility verification step 140 comprises a compatibility extraction sub-step 143 of at least one datum from the pre-set sensitive area 12 of the image 10, for example it is possible to proceed with a reading via OCR of the above-mentioned parts such as the serial number portion or release or expiration dates.

The process 100 comprises a step for verifying compatibility discrepancies 240 between the data extracted from the pre-set sensitive area 12 of the image 10 and at least one validity parameter present in the memory.

For example, the publication data can be compared with the serial number extracted from the image by comparing it with the serial numbers of original documents present in the memory and published in the same time period.

Finally, the process 100 comprises the step of generating the result of the verification 160 which assigns a score or a statistical weight to the data based on its correspondence with one or more parameters of validity and helps to determine the originality or falsity of the document of recognition based on the correspondence between the datum extracted from the pre-set sensitive area of the image and the validity parameter present in the memory.

The process 100 comprises an evaluation step 150 of all those parts which refer to international rules including a calculation of any safety algorithms. The evaluation step 150 provides for the verification of at least one section 11 of the image 10 of the document where there are pre-set sensitive areas 12 including international rules.

The validity verification step 150 comprises a validity identification sub-step 151 of at least one pre-set sensitive area 12 which provides for identifying a presence of the pre-set sensitive area 12 within the image 10, for example 12 pre-set sensitive areas are identified where there are parts of the serial number of the document or parts of the tax code.

The validity verification step 150 comprises a validity comparison sub-step 152 between the pre-set sensitive area 12 within the image 10 and at least one pre-set sensitive area 12 of at least one comparison image of at least a sample identification document present in the memory, for example the data of the serial numbers are compared with algorithms present in the memory.

The validity verification step 150 comprises a sub-step for extracting the validity 153 of at least one datum from the pre-set sensitive area 12 of the image 10, for example it is possible to proceed with a reading via OCR of the above-mentioned parts such as the part of the serial number or the fiscal code.

The process 100 comprises a step for verifying any differences in validity 250 between the data extracted from the pre-set sensitive area of the image 10 and at least one validity parameter present in the memory.

For example, it is possible to verify through the calculation algorithm whether the serial number or the tax code match.

Finally, the process 100 comprises the step of generating the result of the verification 160 which assigns a score or a statistical weight to the data based on its correspondence with one or more parameters of validity and helps to determine the originality or falsity of the document of recognition based on the correspondence between the datum extracted from the pre-set sensitive area of the image and the validity parameter present in the memory.

The process 100 comprises the step of generating 160 of an analytical result which configures the direct originality or falsity of the document.

The results of the process 100 can be subjected to a further definitive verification step by an expert of the applicant to validate the result of the generation step 160.

The verification process can therefore comprise two steps, a first which is the process 100 and is performed by the processor of the electronic computer on the basis of specific settings and a second step managed by a human specialist during a ‘physical’ examination of the document.

Preferably the data extracted from the pre-set sensitive area 12 is included in a list comprising personal data, gender, expiry date, document number, at least one mathematical algorithm which calculates the data, bar codes, anti-forgery graphic elements, mandatory data of document, date of issue, date of expiration, date of birth document numbers, font of document number, alignment of characters, alignment of sections of document, counterfeit matrices, non-existent data, data inconsistent by date or place of issue, perspective, matrix, passport photo, serial numbers matrix lighting, photography lighting, contrast, colour.

Advantageously, the verification process of the applicant reverses the sequentiality of the two steps as they were understood by the state of the prior art, namely a first step in which the document was physically presented to an operator who, if he had any doubts, would have passed to an automated verification step by means of technological devices.

Advantageously, the process 100 reorganizes a structure of the controls, without renouncing a preventive verification which allows not automatically accepting as true the documents transmitted with modern technologies.

The process 100 advantageously represents a control method which frees the customer from having to face the costs relating to the training of his own personnel, entrusting the analysis to the computerized system of the electronic processor where the process 100 is loaded and, secondly, having a validation of the results of the process 100 to its experts.

Advantageously, the process 100 carries out an automated check on the images 10 of the identification documents, aimed at ascertaining whether these reproduce a document which presents elements of forgery.

Considering that the document cannot be materially analysed, the verdict provided by process 100 can only concern the verification of what is reproduced in image 10, being able to report nothing on the actual existence of the document represented.

It is also agreed that, if false elements are identified, the customer will be well aware of the risks associated with engaging in any type of relationship with his potential user/customer.

As seen above, the process 100 comprises verification steps 110, 120, 130, 140, 150 which mainly concern two macro areas: verifications of a logical type and verifications of a graphical type.

Each verification step 110, 120, 130, 140, 150 can include both logical verification steps and graphic verification steps.

The logical verification steps include at least one of: a step of comparison between data of birth, gender, expiration date, document number with the corresponding parts entered in strings according to ICAO standards; a step for verifying the correctness of the mathematical algorithm result of an ICAO code; a step for verifying the correctness and congruence of barcodes; a step for verifying the presence/absence of anti-forgery graphic elements; a step for verifying the presence/absence of mandatory data; a consistency check step in a data correlation, such as a release/expiration/birth date; a step of comparison with document numbers already present in the archive memory.

The graphic verification steps comprise at least one of: a verification step of a correctness of the fonts of the document number; a step of verification of comparison with fonts in the archive memory already identified as false; a verification step for checking the correct alignment of characters/sections of the document; a search step for counterfeiting matrices already present in the archives of the process memory 100; a step of comparison with faces in the archive already identified as fake; a step for verifying the presence of non-existent/inconsistent characteristics by date-place of issue; a step for verifying differences in definition between different zones 12 of image 10; a step for verifying the difference in perspective between the matrix/passport photo/personal data/serial numbers); a step of difference between illumination of the matrix and that of the photograph.

Advantageously, the process 100 comprises a final data archiving step. The data analyzed by the system are restructured into unintelligible files which are subsequently archived in digital format. The files will be used by the system functions to make comparisons with the new input data. This will make it possible to verify whether the data (face, personal data, counterfeiting matrix) has already been analyzed by the process 100 and whether it has been associated, in the past, with a document which turned out to be true or false. In the event of a forgery, this step of the process 100 will return an alert and the input data will undergo a more in-depth check by a human specialist.

Advantageously, as regards the controls implemented by the process 100, it uses specific techniques for each type of document, autonomously identifying the type of document and applying, each time, the different analysis and verification techniques 120-150 described above.

With regard to any document, the process 100 acquires 110 at least one image of the document to be analysed, and applies the series of verification methods 120-150 described above through both logical verification steps and graphic verification steps.

For example, logical verifications can include at least one verification of this list: a spelling check of pre-printed wordings, presence of numerical data in the ‘height’ field, congruence of the font of the no. document serial, structure of serial no., structure of personal no., correspondence between expiry date and issue date, expiry date included within the terms of the law, absence of prohibited characters in the no. serial number, day and month of expiry identical to the day and month of birth of the holder, verification of the heraldry on the stamp, expiry date prior to today's date (expired document), verification of the expiry of the document in relation to vehicle category and age of the holder, verification of the toponymic existence of the residence addresses, analysis of birth certificate details, compatibility of the expiry date with the categories of vehicles and the age of the holder, an analysis or verification of the security hologram, a correspondence between serial number front/reverse (ICAO), analysis of the ICAO code, calculation of the tax code from personal data, correspondence between the calculated tax code (tax code) and the printed in another pre-set sensitive area 12 of the document, correspondence between tax code calculated and the printed on another pre-set sensitive area 12 of the document, correspondence between cf. calculated/cf. on barcode, correspondence between tax code printed on verso/tax code barcode, black/white photograph of the holder, correspondence between the indication of the holder's gender (M or F) with that indicated in the ICAO code, calculation and verification of the Luhn code present in the card number, verification of the dimensions of the logo indicating the presence of RFID, verification of counterfeiting matrices, evaluation of bilingual models, comparison between photos on the front and back of the form, verification of photographs in grayscale or color based on the date of issue of the document.

For example, graphic verifications can include at least one verification of this list: presence of anti-forgery graphic elements, verification of the clear background of the passport photo, correctness of the fonts of the document no., congruence of the distance between serial no. and inking rectangle in relief, correct alignment of characters/sections, verification of counterfeiting matrices, search for counterfeiting matrices already present in the memory archives, presence of non-existent/inconsistent graphic characteristics by date-place of issue, difference in perspective between matrix/passport photo/personal data/serial numbers), difference between illumination of the matrix and that of the photograph, differences in definition between different areas of the image, comparison with faces in the archive already present on false documents, analysis of wet stamp impressions (where present) of the municipalities of issue with heraldic verification, orthographic analysis of the impressions of the stamps of registry officials, evaluation of bilingual and consular models, y and/or left alignment of data labels (front/back), font of the holder's personal details (name/surname) of correct dimensions based on the year of issue of the document, verification of the composition of the personal number with shifting of letters according to the date of issue, presence of the flag and/or its alignment and/or position on the document, alignment of part of the personalization data, analysis of the methods of imprinting the polygraphic number (font and print characters), correct spacing between the two lines of the ICAO code, correct spacing between the expiry date and the first line of the ICAO code, verification of the correct numbering of the pages, verification of the alignment between numbers and graphic details of the document, evaluation of the bilingual model, temporal verification of the presence of graphic details in the print background, x-y alignment of the Braille characters.

It is possible to provide for further logical or graphical checks depending on the Italian or foreign institution that publishes identification documents.

The verification steps 110, 120, 130, 140, 150 comprise an image recognition step of the document or part of the document by means of the image 10 or at least one section 11 of the image 10.

The recognition by images by the steps 110, 120, 130, 140, 150 of the process 100 provides that an artificial intelligence is instructed to recognize at least predefined areas 12 of the document, therefore when the processor analyzes at least one section 11 of the image 10 uses an artificial intelligence module to verify that this predefined area 12 is also present in the section 11 of the image 10.

More generally, the image recognition step provides that an artificial intelligence is instructed to recognize at least one pre-set sensitive area 12 and the processor that performs the verification step 110, 120, 130, 140, 150 analyzes the image 10 by means of the artificial intelligence to verify that the pre-set sensitive area 12 of at least one predefined image of the document present in memory is also present in the image 10.

For example, step 101 provides that artificial intelligence (A.I.) learns to recognize the various document models (license, C.I., passports, etc.) by administering specimens. The document is reconstructed from step 101 by means of a coordinate grid and template. In particular, the latter, with known content in terms of alphanumeric content/structure, make it possible to identify the document under analysis.

The image recognition of the process 100 provides for verifying alignments and distances between graphic elements.

On the original document, the personal data are printed in a single solution by the mechanographic device. As a consequence of this, the strings will be aligned with each other by identifying the first available pixels in the first character and in the first character of the last line of the block. The straight line must develop at a constant average distance (no. of pixels/spaces) between the various strings, according to a tolerance deemed congruent during the programming step. This type of control results is particularly effective for identifying ‘artisanal’ fakes, created on screen by manually entering the data, or in those documents physically produced using low-quality commercial printers (in both cases, the alignments will be random).

CV algorithms are used to extract the alignments from the image 10 or from sections 11 thereof, using the technique of dividing 102 of the image 10 into sections 11 template matching, returning this of the coordinates (x, y) in which it found the portion to be searched, having normalized the image to a fixed size, it is possible to compare the coordinates (x, y) between various elements of the document, therefore any alignments, taking into account a dynamic tolerance coefficient, which varies according to the type of document.

To verify the alignments and distances between graphic elements, the processor uses a pre-trained artificial intelligence module which identifies the sections 11 of the image 10 where the alignment is present and then the processor verifies that the alignment corresponds to that of the original document, where the alignments are to be considered as pre-set sensitive areas 12.

To carry out verification on fonts or stamps, the font is verified, for example by the processor with the alphanumeric specimen. Each character of the serial number of the document in question is treated through computer graphics algorithms, isolated, cleaned of the background, the color, trimmed in the outlines and compared with the original font (this is a ‘similarity’ test based on a ‘delta’ oscillating between 0 and 1). The stamps, on the other hand, not always present as they are not mandatory, are verified by the processor in their content by algorithms of the process which are OCR readers capable of identifying and reading strings of data in circular form. In relation to the coat of arms of the issuing Municipality, it will be compared with a memory library containing the coats of arms of the Municipalities. However, this type of control can be integrated into the verification step by specialists.

By evaluation of the bilingual model, we mean that the bilingual document model differs from the standard one both in terms of color and content. The color would be identified by the processor which carries out the process 100 and the templates would associate the pre-printed wordings (for example, name, surname, date of birth, residence, etc.) with the respective translation placed immediately below. In other words, reading the data in French must correspond to a blue document, green if German, etc.

The predefined areas 12 which represent graphic elements and/or anti-forgery matrices and/or graphic particularities in the print background of the document can be exemplified as follows.

Over time, but in periods known to the specialists who have implemented the process 100, there are printing errors in the production of the various original document templates. These errors can be used to check whether the release date of the document under analysis is consistent with the error present in the background printout. The same strategy can be used when text or a pre-printed graphic element is modified: knowing the date and content of the modification, it is possible to verify correspondence with the apparent release date of the document.

Forgers often have a single ‘blank’ stub of a document and use it to produce a mass of forged documents. Once the ‘counterfeit matrix’ has been identified (e.g. without an accent on a particular letter, containing a particular spelling error, etc.) it can be recognized by the system and signaled with an ALERT. The same method is associated with the recognition of faces (facial biometrics) already identified within FALSE documents and stored in the archives in memory: if one of these faces should appear within the document under analysis, an ALERT will be generated.

As regards the logical and graphical verification steps, both computer graphics algorithms and at least one artificial intelligence module trained through an upstream information administration are used.

As far as computer graphics algorithms are concerned, an image manipulation 10 to be better understood by the artificial intelligence machine learning algorithm for text understanding (OCR) are carried out in Computer Vision (CV), for example by interception of alignments, logos, or other graphic elements, through template research on a CV basis. The Computer Vision operations carried out in the steps of the process 100 include for example algorithms of the known state of the art such as: erosion, dilation, opening, canny, blur & sharpening, color management HSV, find contours, match Template.

As regards the previously trained artificial intelligence module, the processor preferably supplies this module with sections 11 of the image 10 so as to speed up the verification steps 110, 120, 130, 140, 150 of the process 100.

For example, the division step 102 envisages normalizing the entire input image 10 to a fixed size, searching for templates or sections 11, previously cut out within the image 10, finding the coordinates of these templates 11, being all the dimensions “normalized” it is possible to set a relative area (Coordinates) where to find the data, once the data is retrieved this portion is processed by the CV algorithms, the post-produced image is sent for example to the AI artificial intelligence module to perform, for example the reading operation via OCR.

For the interpretation of the text, the steps of the process 100 use an OCR system based on AI (Machine Learning). There are basically two scenarios.

Use of an OCR of open source origin, on which a predefined training has been carried out using “proprietary” data, which we will define as “internal” OCR.

Use of “external” OCR, from third parties, trained by external suppliers or, where foreseen, carried out a fine-tuning operation, i.e. improvement.

Within the documents there is obviously a photo of the person which is used to be compared with other images present in a reference, proprietary database in order to verify their identity, if any, compare photos of the same person between various documents, for example verifying that the same name does not have two different faces.

The same considerations made in the previous paragraph on OCR apply to this area.

As regards the recognition of the face by the verification steps of the process 100, the recognition process comprises at least the steps of identifying the photo in the document through AI or template-based CV algorithms, cropping the photo, applying CV algorithms to improve its quality, pass input to an AI based on Deep Learning, with autoencoder architecture, previously trained using “proprietary” material, in the central part of the autoencoder model a biometric signature is actually extracted (typically from 128 to 512 bytes in point mobile) which is used for searching and comparing within the dataset.

Therefore, the entire image is not memorized, at least in relation to the need for the pure facial recognition operation, but its biometric signature.

Alternatively for facial recognition, the process includes at least the steps of: identifying the photo in the document using AI or template-based CV algorithms, cropping the photo, applying CV algorithms to improve its quality, sending to the external identification service/facial recognition which will return True/False response if the face exists/matches.

Alternatively, and more generally, it is possible to provide that the process 100 comprises the step of identification of the document 101 and at least one of the verification steps 110, 120, 130, 140, 150, finally the step of generation of the result 160 as shown in the figure.

The image recognition process 100 operates for verifying a veracity of an identification document by means of an administration of at least one image 10 of the identification document, wherein the process 100 is implemented on an electronic processor comprising at least one processor to perform operations of the process 100 and at least one memory, in which the process 100 comprises an acquisition step 101 of the image 10, at least one verification step 110, 120,130, 140, 150 which verifies the presence of pre-set sensitive areas 12 at the interior of the image 10, which comprises a non-conformity verification sub-step 111, 121, 131, 141, 151 which provides for a comparison between the pre-set sensitive areas 12 within the image 10 and sensitive areas preset 12 of comparison images present in the memory, a generation step 160 of an outcome which determines the originality or falsity of the document.

Alternatively, it is possible to provide that the acquisition process 101 does not include the division step 102 and that the entire image is used by the verification steps 110, 120, 130, 140, 150 of the process 100.

The process 100 can be implemented in command lines of a software suitable for running on the electronic computer.

The presently disclosed subject matter thus conceived is susceptible to numerous modifications and variations, all falling within the scope of the inventive concept. In practice, the materials used, as well as the dimensions, may be any according to the technical requirements.

1. An image recognition process to verify an authenticity of a recognition document by means of an acquisition of at least one image of the recognition document, wherein the process is implemented on an electronic computer comprising at least one processor for performing operations of the process and at least one memory, the process comprising:
a step of acquisition of, the image of the recognition document, comprising a division sub-step that divides the image into a plurality of image sections that correspond to pre-set sensitive areas of the image;
a plurality of verification steps comprising a type verification step, a structural control step, compilation analysis step, a compatibility verification step, an evaluation step, able to identify a presence of the pre-set sensitive area within the image, to perform a comparison between the pre-set sensitive area within the image and at least one pre-set sensitive area of at least one comparison image of at least one sample recognition document present in a memory, and to extract at least one data item from the pre-set sensitive area of the image;
a plurality of discrepancy verification steps between the data item extracted from the pre-set sensitive area of the image and at least one validity parameter present in memory,
a step of generation of an outcome which determines the originality or falsity of the recognition document based on a match between the data item extracted from the pre-set sensitive area of the image and the validity parameter present in memory, wherein the step of generation of an outcome is based on a result of the sum of a multiplicity of statistical weights assigned to a multiplicity of the data item extracted from the pre-set sensitive area of the image.

2. The process of claim 1, wherein the plurality of verification steps comprise:
a sub-step of identification of at least one pre-set sensitive area that provides for identifying a presence of the pre-set sensitive area within the image;
a sub-step of comparison between the pre-set sensitive area within the image and the pre-set sensitive area of the comparison image of at least one sample recognition document present in the memory;
a sub-step of extraction of the data item from the pre-set sensitive area of the image.

3. The process of claim 1, wherein the at least one verification step is a step of type verification of the recognition document based on the image for establishing the type of the recognition document based on at least one sensitive area of the image.

4. The process of claim 1, wherein the verification step is a step of structural control of the document based on the image, wherein the pre-set sensitive area of the image concerns structural elements of the document.

5. The process of claim 1, wherein the verification step is a step of analysis of the compilation of the document based on the image, wherein the pre-set sensitive area of the image concerns compiled elements.

6. The process of claim 1, wherein the verification step is a step of compatibility verification of the document based on the image, wherein the pre-set sensitive area of the image concerns particular graphics and/or fonts of characters and/or drawings that are used during a period of time in which the document is published.

7. The process of claim 1, wherein the verification step is a step of evaluation of the document based on the image, wherein the pre-set sensitive area of the image concerns parts of the image that refer to international rules of the document.

8. The process of claim 1, wherein the discrepancy verification step comprises a sub-step of score reporting that assigns a statistical weight to each data item extracted based on the match of the data item extracted with the validity parameter and compares:
the data item extracted from at least one of the pre*set sensitive areas of the image with at least one data item extracted from other pre-set sensitive areas of the same image;
the data item extracted from at least one of the pre-set sensitive areas of the image with the data item extracted from pre-set sensitive areas of sample recognition documents;
the data item extracted from at least one of the pre-set sensitive areas of the image with the ranges of data of sample recognition documents;
the data item extracted from at least one of the pre-set sensitive areas of the image with a result of the extracted data item calculated by means of algorithms for calculating data of sample recognition documents.

9. The proces of claim 1, wherein the data item extracted from pre-set sensitive area is included in a list comprising personal data, sex, expiration, document number, at least one mathematical algorithm that calculates the data item, bar codes, anti-counterfeiting graphic elements, mandatory data of the document, date of issue, expiration date, date of birth, document numbers, font of the document number, character alignment, alignment of sections of the document, counterfeit matrices, nonexistent data, inconsistent data by date of issue, perspective, matrix, photocard, serial numbers illumination of the matrix, illumination of the photograph, contrast, colour.

10. The process of claim 1, wherein the at least one verification step comprises a step of image recognition of the document or part of the document by means of the image, wherein the image recognition step provides that an artificial intelligence is instructed to recognise at least one pre-set sensitive area and the processor performing the verification step analyses the image by means of the artificial intelligence to verify that the pre-set sensitive area of at least one predefined image of the document present in memory is also present in the image.

11. The process of claim 10, wherein the artificial intelligence is pre-instructed based on a training by means of a delivery of original documents from the memory.

12. A computer program loadable into a memory of an electronic computer comprising instructions which, when the program is executed by the computer, implement an image recognition process to verify an authenticity of a recognition document by means of an acquisition of at least one image of the recognition document according to claim 1.
